(19) United States
(12) Patent Application Publication
(10) Pub. No.: US 2013/0154488 A1
(43) Pub. Date: Jun. 20, 2013

(54) Dimmable LED Driver with Multiple Power Sources

(71) Applicants: Laurence P. Sadwick, Salt Lake City, UT (US); William B. Sackett, Salt Lake City, UT (US); Jared Wyckoff, Salt Lake City, UT (US)

(72) Inventors: Laurence P. Sadwick, Salt Lake City, UT (US); William B. Sackett, Salt Lake City, UT (US); Jared Wyckoff, Salt Lake City, UT (US)

(21) Appl. No.: 13/674,072

(22) Filed: Nov. 11, 2012

Related U.S. Application Data
(60) Provisional application No. 61/558,512, filed on Nov. 11, 2011.

(51) Int. Cl. H05B 37/02

(52) U.S. Cl. CPC H05B 37/02
USPC 315/172

(57) ABSTRACT

A dimmable LED driver with multiple power sources.

### BACKGROUND

Electricity is generated and distributed in alternating current (AC) form, wherein the voltage varies sinusoidally between a positive and a negative value. However, many electrical devices require a direct current (DC) supply of electricity having a constant voltage level or constant current level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which are often higher than may be desired for a high efficiency LED light. Some conversion of the available power may therefore be necessary or highly desired with loads such as an LED light.

In one type of commonly used power supply for loads such as an LED, an incoming AC voltage is connected to the load and current is drawn only during certain portions of the sinusoidal waveform. For example, a fraction of each half cycle of the waveform may be used by connecting the incoming AC voltage to the load each time the incoming voltage rises to a predetermined level or reaches a predetermined phase and by disconnecting the incoming AC voltage from the load each time the incoming voltage again falls to zero or capacitors that are used in the power supply circuit may charge only near the peak of, for example, the rectified AC input voltage. In this manner, a positive but reduced voltage may be provided to the load. This type of conversion scheme is often controlled so that a constant current is provided to the load even if the incoming AC voltage varies. However, if this type of power supply, and, often, other types of power supplies, with current control is used in an LED light fixture or lamp, a conventional dimmer is often ineffective. For many LED power supplies, the power supply will attempt to maintain the constant current through the LED despite a drop in the incoming voltage by increasing the on-time during each cycle of the incoming AC wave.

In a power supply for loads such as an LED, internal circuits or devices such as a variable pulse generator may derive power from a DC line. A need remains for a more efficient power source for internal circuits or devices.

### SUMMARY

The present invention obtains power from multiple sources for use by circuits such as, for example, a variable pulse generator in a dimmable LED driver and in other applications and with other loads. The present invention is applicable to more than just dimmable LED drivers and power supplies and can, for example be applied to other types of LED and lighting drivers, power supplies and ballasts, including but not limited to dimmable and non-dimmable LED, OLED, florescent lamps (FLs), compact FLs (CFLs), cold cathode FLs (CCFLs), high intensity discharge lamps (HIDs), AC to DC, AC to AC, DC to AC and DC to DC low voltage lighting power converters and inverters and other types of power supplies for a wide, diverse and general use, including but not limited to, battery chargers, laptop power supplies, television and computer power supplies, AC to DC power supplies, AC to AC power supplies, DC to DC power supplies and DC to AC power supplies and, in general inverters and converters and power supplies of all types including isolated and non-isolated power supplies. The multiple power sources may be configured in some embodiments to automatically select an active power source based on an input voltage level to the system. By switching between multiple power sources, power is supplied to circuits such as a variable pulse generator with increased efficiency. The embodiments shown in this document are to be viewed as being representative and not limiting in any way or form. Although the present invention is described with LED power supplies in mind, the present invention can be applied to and is valid for more general types of power supplies including non-LED power supplies and power supplies designed for constant current, constant voltage, constant power or any combination of these.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of a dimmable LED driver with multiple power sources, including a tag-along inductor, in accordance with some embodiments of the invention;

FIG. 2 depicts a block diagram of a dimmable LED driver with multiple power sources, including a transformer, in accordance with some embodiments of the invention;

FIG. 3 depicts a block diagram of a dimmable LED driver with multiple power sources, including a tag-along inductor wound in opposite polarity to a main inductor, in accordance with some embodiments of the invention;

FIG. 4 depicts a block diagram of a dimmable LED driver with multiple power sources, including a tag-along inductor, and a load current controller in accordance with some embodiments of the invention;

FIG. 5 depicts a schematic of a dimmable LED driver with multiple power sources, including a tag-along inductor, in accordance with some embodiments of the invention;

FIG. 6 depicts a block diagram of a dimmable LED driver with multiple power sources, including a low side tag-along inductor, in accordance with some embodiments of the invention;

FIG. 7 depicts a block diagram of a dimmable LED driver with multiple power sources, including a low side tag-along inductor, and with load and reference current control with time constants in accordance with some embodiments of the invention;

FIG. 8 depicts a plot of efficiency of a dimmable LED driver versus input voltage when drawing power only from the input line in accordance with some embodiments of the invention;

FIG. 9 depicts a plot of efficiency of a dimmable LED driver versus input voltage over a different input voltage range when drawing power only from the input line in accordance with some embodiments of the invention;

FIG. 10 depicts a plot of efficiency of another embodiment of a dimmable LED driver versus input voltage when drawing power only from the input line in accordance with some embodiments of the invention;

FIG. 11 depicts a marker plot of efficiency versus voltage in an embodiment of the dimmable LED driver with multiple power sources in accordance with some embodiments of the invention; and

FIG. 12 depicts a line plot of efficiency versus voltage in an embodiment of the dimmable LED driver with multiple power sources in accordance with some embodiments of the invention.

### DESCRIPTION

The multiple power source system disclosed herein obtains power from multiple sources for use in powering any electronic circuits or devices. For example, the multiple power source system may be used to provide power to internal circuits in a dimmable LED driver, such as the various dimmable LED drivers and their variations disclosed in U.S. patent application Ser. No. 12/422,258, filed Apr. 11, 2009 for a “Dimmable Power Supply”, which is incorporated herein by reference for all purposes. In some embodiments, power may be provided to charge one or more batteries or other energy storage devices.

Power may be obtained from sources such as but not limited to an AC or DC line, a tag-along inductor that inductively couples to another inductor in an electrical circuit, a battery, solar cells, photovoltaics, vibrational, heat, mechanical, sources, etc.

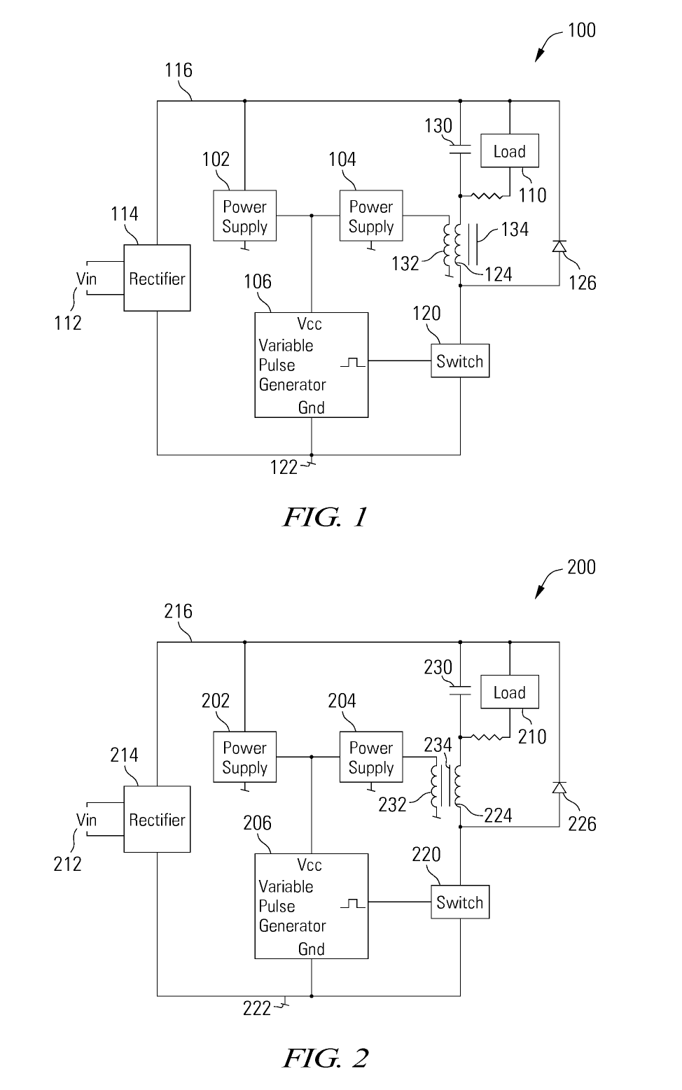

Turning to FIG. 1, an embodiment of a dimmable LED driver 100 is shown that includes multiple power sources 102 and 104 to supply power to internal devices and circuits such as a variable pulse generator 106. The term “power source” is used herein to refer to the origin of a voltage or current, in contrast to a circuit such as a voltage regulator that may scale, limit or otherwise process the voltage and/or current levels obtained from the power source. Examples of power sources include but are not limited to AC and/or DC lines, tag-along inductors, transformers, batteries, energy harvesting sources such as solar, photovoltaic, mechanical, vibrations, wireless, etc.

The dimmable LED driver 100 powers and controls a load 110 such as one or more LED lights, from a power source such as an AC input 112. A rectifier 114 may be used to convert the AC input 112 and provide a DC signal to a DC rail 116. A switch 120 is controlled by the variable pulse generator 106, blocking or allowing current to flow from the DC rail 116 to a return rail 122 through the switch 120. As current flows through the switch 120, it also flows through a series inductor 124, storing energy in the inductor 124. When the switch 120 is turned off by the variable pulse generator 106, the inductor 124 released energy, which circulates through a diode 126 and through the load 110. As will be understood by those of ordinary skill in the art, other components may be included such as capacitor 130 illustrated in parallel with load 110, and other devices to facilitate the desired functionality in the dimmable LED driver 100. In other embodiments, the load may consist of one or more capacitors in parallel with the LED(s), etc. In other embodiments and applications, the load may consist of things other than LEDs, OLEDs, etc., such as, but not limited to resistive, capacitive, inductive, reactive, etc. and/or combinations of the these, etc.

The first power source 102 draws power from the DC rail 116, regulating or dividing or otherwise setting the voltage level at an appropriate level, for example, for the variable pulse generator 106. The second power source 104 draws power from an inductor 132 adjacent the main inductor 124, inductively coupling power flowing through the main inductor 124 into the power source 104.

The inductor 132 may be located adjacent to the main inductor 124 in any suitable manner, for example by winding the inductor 132 around or along with the inductor 124. The inductors 124 and 132 may share a core 134, and the relative placement of the windings of inductors 124 and 132 and the core 134 is not limited to any particular arrangement, as illustrated in FIGS. 1 and 2.

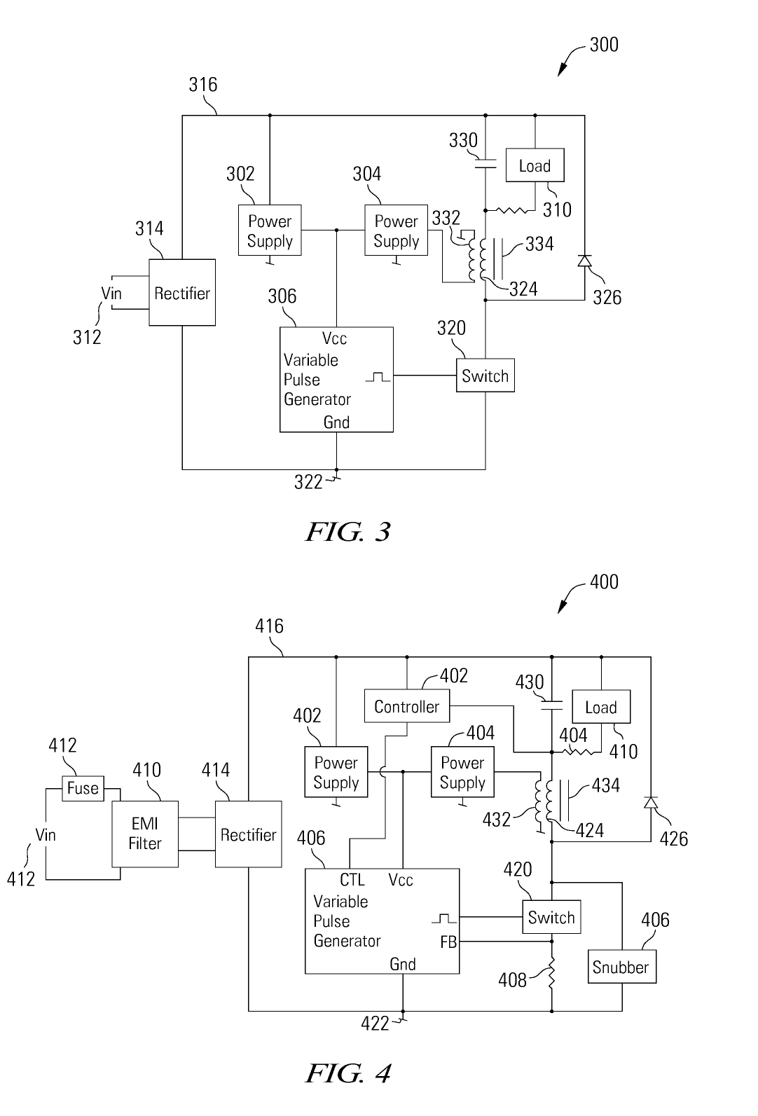

Turning to FIG. 3, the inductor 132 may be wound with an opposite polarity. When wound with one polarity, when the voltage and current in the inductor 124 is limited and, for example, the LED power supply/driver is either in constant current or voltage mode, the voltage from the power source 104 is constant. When wound with the other polarity, the inductor 132 and power source 104 are in the forward mode, and when the input voltage at DC rail 116 goes up, the voltage from the power source 104 goes up. Additional power may be supplied from other sources such as snubbers and clamps and other types of energy storage devices and components including but not limited to inductors or capacitors of any type and combinations of these. As mentioned above, batteries, solar cells, photovoltaics, vibrational, mechanical, heat, thermal, wired, wireless, RF, etc. sources of energy may also be used with the present invention.

As disclosed above, the multiple power sources are not limited to use in any particular application. Turning to FIG. 4, another example of a dimmable LED driver 400 is illustrated. In this embodiment, a controller 402 measures the load current through a sense resistor 404, and controls the variable pulse generator 106 based in part upon the load current. In some versions a level shifter or isolator may be included and may be used to feed the signal from the sense resistor 404 to the controller 402 or a sense transformer or other such device may be used as well as transistors to convey information about the current through the load 26. Other embodiments of the present invention may use other methods to sense current including, but not limited to, current transformers, voltages across or through components, turns of wire, magnetic sensors, etc. As mentioned above, although not required for the present invention, some applications and/or embodiments may use level shifters, optocouplers, opto-isolators, transistors, etc. as part of the feedback. The present invention may or may not use such level shifting and is, in no way or form, limited to the use or non-use of level shifting, etc. The variable pulse generator 106 may further be controlled by the current level through the switch 120 as measured by another sense resistor 408 or other means. A snubber circuit 406 may be included to suppress transient voltages and improve noise performance, etc. One or more clamp circuits may also be used. As mentioned above, the energy and associated power with the snubber(s) and/or clamp(s)may be used as part of the multiple power sources. An EMI filter 410 may be included to reduce electromagnetic interference, and a fuse 412 may be included to protect against short circuits, etc. In some configurations it may be possible to use the EMI filter as a power source.

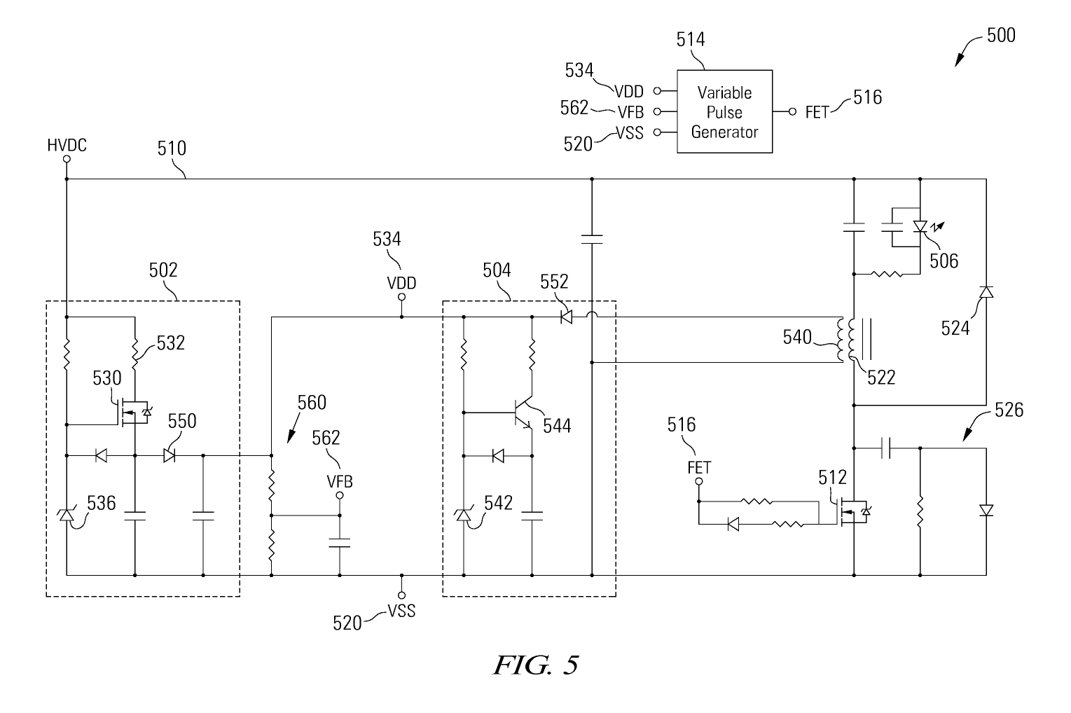

An example embodiment of a dimmable LED driver 500 with multiple power sources 502 and 504 is illustrated in FIG. 5. The dimmable LED driver 500 is illustrated in more detail, however, it is important to note that the multiple power sources 502 and 504 are not limited to use with the dimmable LED driver 500 of FIG. 5, nor to the specific details of the multiple power sources 502 and 504, which are merely examples. Although two power sources are illustrated in the example drawings, in general, N power sources may be used where N is greater than 1 (i.e., N=2, 3, 4, etc.).

The dimmable LED driver 500 powers and controls a load such as one or more LED lights 506, from a power source such as a DC rail 510, which may be derived from an AC input using a rectifier as disclosed above. A transistor 512 is controlled by a variable pulse generator 514 or other control circuit through a FET control signal 516, blocking or allowing current to flow from the DC rail 510 to a ground 520 through the transistor 512. Again, in this example embodiment, as current flows through the transistor 512, it also flows through a series inductor 522, storing energy in the inductor 522. When the transistor 512 is turned off by the variable pulse generator 514, the inductor 522 releases energy, which then circulates through a diode 524 or other secondary path and through the LED 506.

Other components may be included, such as a snubber circuit 526. One or more optional capacitors may be connected in parallel with the load as shown. Again, these other components may be also used as a power source.

In the first power source 502, current flows through a transistor 530 and resistor 532 to a VDD voltage node 534. A Zener diode 536 limits and sets the voltage level that may be supplied by the power source 502.

In the second power source 504, current flows from an inductor 540 wound with inductor 522 to the VDD voltage node 534, with the voltage supplied by the power source 504 set and limited by a Zener diode 542 and voltage regulating transistor 544. Notably, in embodiments where regulation is not needed, the voltage regulating transistor 544 and associated components are not included, and the VDD voltage node 534 is driven directly from inductor 540 through diode 552. Similar changes may be made in power source 502.

The selection of one or both power sources 502 or 504 to supply VDD voltage node 534 is set by diodes 550 and 552. If the voltage from power source 502 is greater than that from power source 504, the diode 552 in power source 504 will be reverse biased and power source 504 will not supply current to VDD voltage node 534. If the voltage from power source 504 is greater than that from power source 502, the diode 550 in power source 502 will be reverse biased and the power source 502 will not supply current to VDD voltage node 534. Although the selection of power sources in the above example embodiment involved diodes, the present invention is in no way limited to the use of diodes only; the selection can be made, for example, by diodes, switches, transistors, other types of semiconductor and active and passive components, digital and/or analog methods, techniques, approaches, etc., by monitoring and selecting certain voltage values, etc. These examples are meant to be illustrative and in no way or form limiting for the present invention.

The present invention can be used in high power factor (PF) circuits with or without dimming including triac, forward and reverse dimmers, 0 to 10 V dimming, powerline dimming, wireless and other wired dimming, DALI dimming, PWM dimming, DMX, etc., as well as any other dimming and control protocol, interface, standard, circuit, arrangement, hardware, etc.

In the example embodiment of FIG. 5, a voltage divider 560 generates a feedback signal 562 used by the variable pulse generator 514 to control the transistor 512.

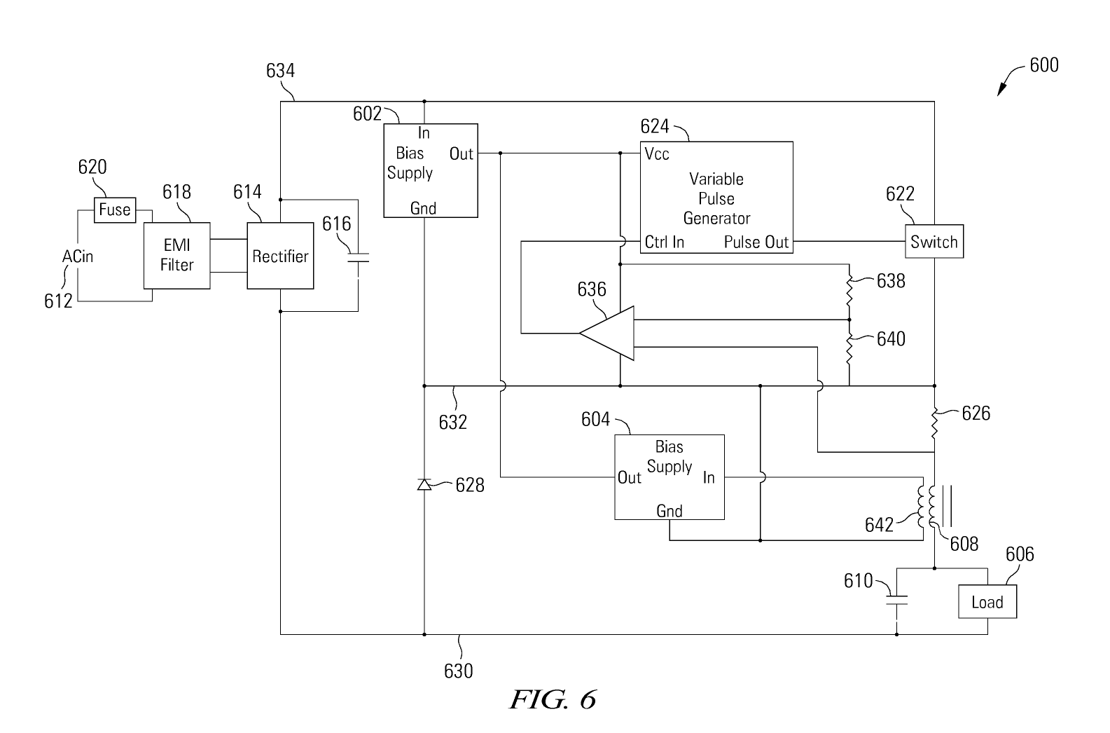

Turning to FIG. 6, the dimmable LED driver 600 with multiple power sources 602 and 604 may also be used in embodiments having a load 606 below the main inductor 608. As before, a capacitor 610 may be connected in parallel with the load 606. The dimmable LED driver 600 powers the load 606 from an alternating current (AC) input 612. A feedback loop based on the current through the switch 30 causes, as an example but in no way limiting or limited to, the variable pulse generator 32 to control the switch 30 to adjust the current through the switch 30 and therefore through the load 12. The AC input 612 is rectified in a rectifier 614 such as a diode bridge and may be conditioned using a capacitor 616. An electromagnetic interference (EMI) filter 618 may be connected to the AC input 612 to reduce interference, and a fuse 620 may be used to protect the dimmable LED power supply 600 and wiring from excessive current due to short circuits or other fault conditions. In some embodiments, a short circuit protection may be employed in addition to fuse protection, etc.

Current to the load 606 is regulated or controlled by a switch 622 such as a transistor or other switch, under the control of a variable pulse generator 624. A sense resistor 626 is placed in series with the switch 622 or in any other suitable location to detect the current through the switch 622 or any other desired current, for use in controlling the switch 622. The main inductor 608 is connected in series with the switch 622, and the load 606 and a parallel capacitor 610 are also connected in series with the switch 622 and the main inductor 608. A diode 628 is connected between the system ground 630 and a local ground 632. When the switch 622 is turned on, current flows from the positive rail 634 through the switch 622 and through the load 606 and energy is stored in the main inductor 608. When the switch 622 is turned off, energy stored in the main inductor 608 is released through the load 606, with the diode 628 providing a return path for the current through the load 606 and back through the sense resistor 626 and the main inductor 608.

A feedback loop includes, for example, an op-amp 636, with one input connected to a voltage divider (such as resistors 638 and 640) providing a voltage reference based on the positive rail 634, and another input connected to the sense resistor 626 to provide a voltage based on the current through the sense resistor 626 (and therefore through the switch 622 and the load 606). The output of the op-amp 636 is fed back to a control input on the variable pulse generator 624, so that the current through the switch 622 controls the pulse width at the switch 622. The op-amp 636 may comprise a difference amplifier, a summing amplifier, or any other suitable device, component, sub-circuit, circuit, comparator, etc. for controlling the variable pulse generator 624 based on the current through the switch 622 and the voltage at the positive rail 634. In this example, the feedback, control and generation circuits are at the same reference point (i.e., local ground) and can be powered in common, in other embodiments, the feedback circuit, for example, may be at a different potential and have a different local ground; in such embodiments an additional tag-along coupled inductor(s) may be used as a way to provide power to the feedback circuit and, in general, realize increased efficiency. A bias current or voltage may also be provided in any suitable manner, such as using an additional tag-along coupled inductor, linear regulator, or other power supply, whereby the bias current or voltage can be used to control the output current or output voltage. This bias current or voltage, in addition to providing and acting as a power source to the power supply may be used directly or indirectly (i.e., as a scaled version using, for example, a voltage or current divider which could be made up of resistors and/or capacitors) to provide a signal that is used to control and/or limit the output current or output voltage for example. In the present invention, a single tag-along coupled inductor can be used both as a power source and for control/feedback purposes as mentioned above—that is a single tag-along coupled inductor can, for example, provide and produce both the added efficiency of a power source and the control and/or limiting feedback information. Multiple tag-along coupled inductors can also be used as part of the multiple power sources and also to provide control or limiting feedback on, for example, the current or voltage of the power supply(ies) or LED/lighting drivers. In general there can be additional tag-along inductors to provide additional power sources for the present invention and other additional power sources such that use photovoltaics, solar cells, thermal, mechanical, vibrational, wired, wireless, RF, heat, etc.

Components in the dimmable LED driver 600 are powered by either or both the power source 602 that draws power from the positive rail 634 or the power source 604 that draws power from a tag-along inductor 642. Power sources 602 and 604 are merely shown for illustrative purposes and are in no way limiting in any way or form, and any implementation with multiple sources of power is included in the present invention and associated embodiments.

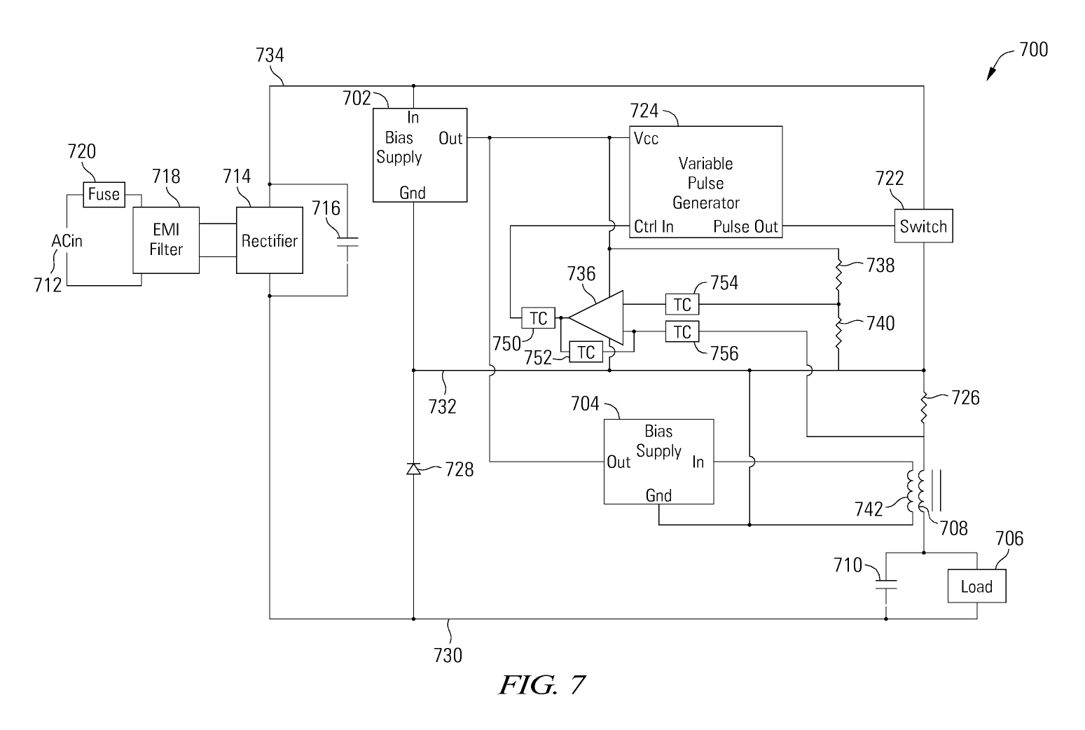

Turning to FIG. 7, time constants 650, 652, 654 and 656 may be included in various locations in the feedback loop or in other locations as desired to implement different control schemes or to adjust the response of the dimmable LED power supply 600. Time constants (e.g., 654 and 656) may be connected to the local ground 632 if and as needed, for example if the time constant consists of an RC network with the signal passing through a series resistor and with a shunt capacitor connected to the local ground 632. If the op amp or comparator 636 in FIG. 7 does not share a common local ground with the control and/or pulse generation circuits than additional power sources as discussed above may be used. In other embodiments the feedback, control and pulse generation may all be combined into one functional unit or integrated circuit.

As illustrated in the efficiency plots and graphs, the power source drawing power from the inductor rather than DC rail has better efficiency when a high voltage is reached. The efficiency curves illustrated in the graphs are merely examples. The point at which the efficiency curve differs between a line source and a tag-along inductor source and at which the efficiency of the tag-along inductor source increases may be chosen and designed to be, take over, begin, etc. at a desired input voltage level. In the examples illustrated in the graphs, the divergence point was selected to be at an input voltage level higher than 120 VAC (at around about 160 VAC) for illustrative purposes.

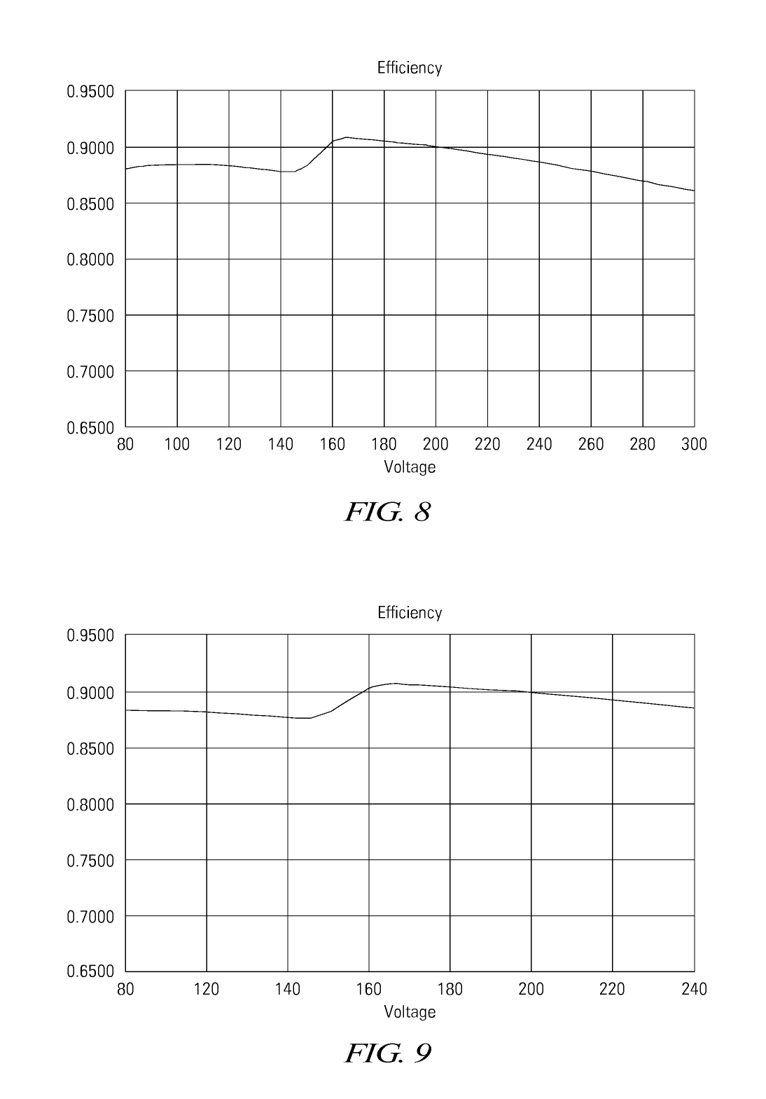

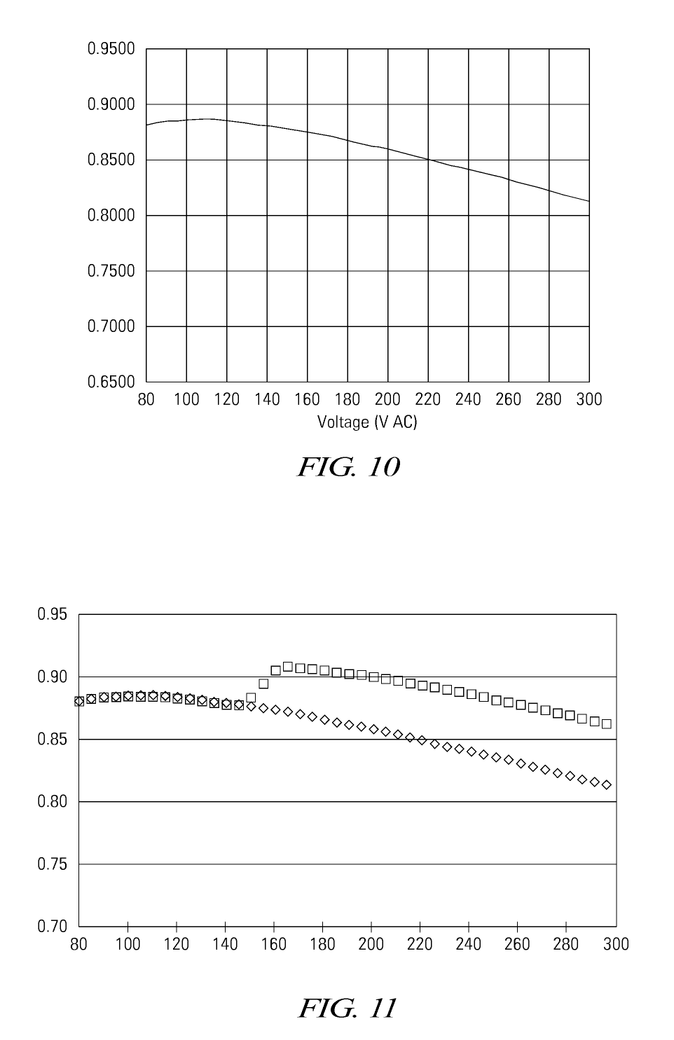

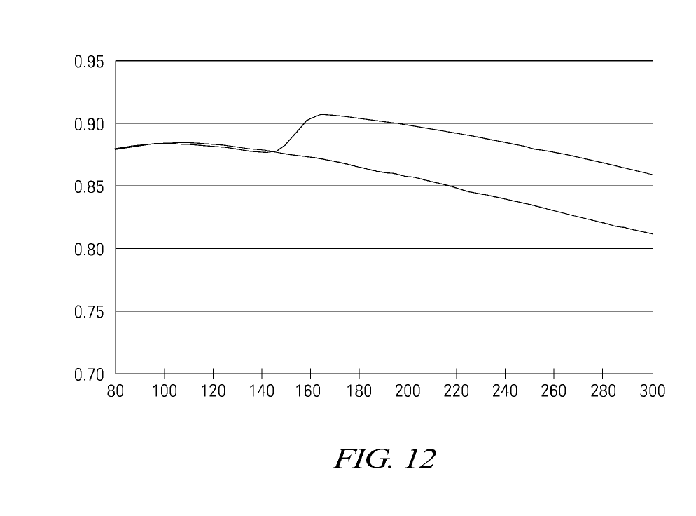

As shown in FIGS. 8-10, the efficiency of power usage in the dimmable LED driver when drawing power from the input line varies based on the input voltage, and in particular, for the examples shown in FIGS. 8-10, tends to decrease as the input voltage increases, although the power supply components in the dimmable LED driver that draw power from the input line can be tailored to provide the best efficiency at the expected line voltage or range of line voltages. Turning to FIGS. 11 and 12, the efficiency versus voltage in an embodiment of the dimmable LED driver with multiple power sources is illustrated, with the upper plot (with marker squares in FIG. 11) showing efficiency when using multiple power sources and the lower plot (with diamond markers in FIG. 11) showing efficiency when powered only from the input line. Because the dimmable LED driver with multiple power sources draws power from the secondary power source at higher voltages, the efficiency is increased by about 5% for the example shown here.

The example embodiments disclosed herein illustrate certain features of the present invention and not limiting in any way, form or function of present invention. Note that linear or switching voltage or current regulators or any combination can be used in the present invention and other elements/components can be used in place of the diodes, etc.

The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs)such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, n-channel or p-channel or both, vacuum tubes including diodes, triodes, tetrodes, pentodes, etc. and any other type of switch, etc. The present invention can, for example, be used with any type of power supply configuration and topology, including but not limited to, continuous conduction mode (CCM), critical conduction mode (CRM), discontinuous conduction mode (DCM), resonant modes, etc., of operation with any type of circuit topology including but not limited to buck, boost, buck-boost, boost-buck, cuk, etc., SEPIC, flyback, etc. In addition, the present invention does not require any additional special isolation or the use of an isolated power supply, etc. The present invention applies to all types of power supplies and sources and the respective power supply(ies) can be of a constant frequency, variable frequency, constant on time, constant off time, variable on time, variable off time, constant period, variable period, etc. Other forms of sources of power including thermal, optical, solar, radiated, mechanical energy, vibrational energy, thermionic, etc. are also included under the present invention. The present invention may be implemented in various and numerous forms and types including those involving integrated circuits (ICs) and discrete components and/or both. The present invention may be incorporated, in part or whole, into an IC, etc.

The present invention supports all standards and conventions for 0 to 10 V dimming or other dimming techniques. In addition the present invention can support, for example, overcurrent, overvoltage, short circuit, and over-temperature protection.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, flyback and forward-converters. The present invention itself may also be non-isolated or isolated, for example using a tag-along inductor or transformer winding or other isolating techniques, including, but not limited to, transformers including signal, gate, isolation, etc. transformers, optoisolators, optocouplers, etc.

The present invention includes other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

When the temperature rises at the selected monitoring point(s), the phase dimming of the present invention can be designed and implemented to drop, for example, by a factor of, for example, two. The output power, no matter where the circuit was originally in the dimming cycle, will also drop/decrease by a some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may provide thermal control or other types of control to, for example, a dimming LED driver. For example, the circuit of FIGS. 1 and 2 or variations thereof may also be adapted to provide overvoltage or overcurrent protection, short circuit protection for, for example, a dimming LED driver, or to override and cut the phase and power to the dimming LED driver(s) based on any arbitrary external signal(s) and/or stimulus. The present invention can also include circuit breakers including solid state circuit breakers and other devices, circuits, systems, etc. That limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design etc., topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

In conclusion, the present invention provides novel apparatuses and methods for supplying circuits from multiple power sources in dimmable LED drivers and in other applications. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for powering a load, comprising:
a power input;
a load output;
a switch operable to control a flow of current from the power input to the load output;
a power storage device operable to store power from the power input when the switch is closed and to release the power when the switch is open;
a pulse generator operable to open and close the switch; and
a plurality of power sources operable to supply power to the pulse generator.

2. The apparatus of claim 1, wherein the plurality of power sources are operable to automatically change from one of the plurality of power sources to another of the plurality of power sources as a primarily active power source for the pulse generator based at least in part on a voltage level at the power input.

3. The apparatus of claim 1, wherein at least one of the plurality of power sources comprises a power source circuit operable to draw current from the power input.

4. The apparatus of claim 1, wherein at least one of the plurality of power sources comprises a power source circuit operable to draw power from a point other than the power input.

5. The apparatus of claim 1, wherein at least one of the plurality of power sources comprises a power source circuit operable to draw power from the power storage device.

6. The apparatus of claim 5, wherein the power storage device comprises an inductor, and wherein the power source circuit comprises a tag-along inductor coupled to the inductor.

7. The apparatus of claim 6, wherein the inductor and the tag-along inductor are coupled with a common polarity.

8. The apparatus of claim 6, wherein the inductor and the tag-along inductor are coupled with an inverse polarity.

9. The apparatus of claim 5, wherein the power storage device comprises a first winding of a transformer, and wherein the power source circuit comprises a second winding of the transformer.

10. The apparatus of claim 1, further comprising a load current controller operable to control the pulse generator to adjust a current to the load output.

11. The apparatus of claim 1, further comprising a comparator operable to control the pulse generator based at least in part on a difference between a reference current and a signal related to a load current.

12. The apparatus of claim 11, further comprising a time constant circuit operable to influence the reference current.

13. The apparatus of claim 11, further comprising a time constant circuit operable to influence a measurement of the load current used by the comparator.

14. The apparatus of claim 11, further comprising a time constant circuit operable to influence an output of the comparator.

15. The apparatus of claim 1, wherein the power storage device is connected at a higher voltage node than the switch, and wherein the load output is referenced to the power input.

16. The apparatus of claim 1, wherein the power storage device is connected at a lower voltage node than the switch, and wherein the load output is referenced to a ground.

17. A method of powering a load, comprising:
generating a pulse stream in a pulse generator;
controlling a switch with the pulse stream to control a flow of current from a power input to a load output;
storing power from the flow of current when the switch is closed and releasing stored power when the switch is open; and
switchably powering the pulse generator from a plurality of power sources.

18. The method of claim 17, wherein the plurality of power sources comprises the power input and a second power source, wherein switchably powering the pulse generator from the plurality of power sources comprises powering the pulse generator from the power input when the power input is at a higher voltage than the second power source, and powering the pulse generator from the second power source when the power input is at a lower voltage than the second power source.

19. The method of claim 18, wherein storing power comprises storing power in an inductor, and wherein the second power source comprises a tag-along inductor coupled to the inductor.

20. The method of claim 18, wherein storing power comprises storing power in a first winding of a transformer, and wherein the second power source comprises a second winding of the transformer.
